(19) United States
(12) Patent Application Publication
(10) Pub. No.: US 2012/0297561 A1
(43) Pub. Date: Nov. 29, 2012

(54) HANDLE FOR A CLEANING DEVICE

(75) Inventors: Norbert Weis, Weinheim (DE); Christoph Zimmermann, Weinheim (DE); Uwe Dingert, Abtsteinach (DE)

(73) Assignees: SP-KLONER ECOTEC S.L., Aldaya - Valencia (ES); CARL FREUDENBERG KG, Weinheim (DE)

(21) Appl. No.: 13/514,250

(22) PCT Filed: Dec. 9, 2010
(86) PCT No.: PCT/EP2010/007484

§ 371 Date: Aug. 8, 2012

(30) Foreign Application Priority Data
Dec. 11, 2009 (DE) 10 2009 057 857.9

(51) Int. Cl. B25G 1/00

(52) U.S. Cl. 15/143.1

(57) ABSTRACT

A handle (1) for a cleaning device (2), comprising a rod (3) consisting of a multilayered, extruded plastic rod is provided.

### CROSS-REFERENCE TO RELATED APPLICATIONS

This application is the national phase of PCT/EP2010/007484, filed Dec. 9, 2010, which claims the benefit of German Application No. 10 2009 057 857.9, filed Dec. 11, 2009.

### FIELD OF THE INVENTION

The invention relates to a handle for a cleaning device and comprises a rod.

### BACKGROUND OF THE INVENTION

Handles for cleaning devices are generally known. Usually such handles are made of a metal rod that is coated with plastic. At one end of the metal rod, a connection piece is arranged, by means of which the handle can be connected, for example, to a mopping plate or a broom body. Wood is an another known material for the handle. To achieve good handling properties it is important that the handle has a certain diameter, so that the handle fits well in the hand and can be guided well. Moreover, a sufficient bending stiffness is required, so that sufficient force can be transferred to the cleaning device attached to the handle. Metal rods and wooden rods have a greater weight if the diameters are larger.

### SUMMARY OF THE INVENTION

The invention is based on an object of providing a handle for a cleaning device, which provides good handling properties and high stability.

To this end, the rod comprises a multilayered extruded plastic rod. Plastics have the advantage of a lower density in comparison to metal materials. This weight advantage is associated with a lower stability. To achieve the required stability, particularly the bending stiffness required for cleaning devices, the handle according to the invention comprises several layers of extruded plastic. With the multiple layers, there are several layers arranged one within the other, which improves the bending stiffness compared to single-layer rods. Furthermore, it is possible to adapt the individual layers to provide particular properties. Thus, layers arranged on the outside can be made from a material that has a particularly comfortable grip and layers arranged inside can exhibit an increased stability, optionally with the aid of additives. According to the invention, at least two layers are provided. However, it is also possible to provide additional layers.

The outer layer can have a different Shore hardness and/or a different friction value than the inner layers. In particular, it is conceivable that the outer layer has a lower Shore hardness and thus a higher friction value than the inner layers. As a result, the handle has a good grip. The harder inner layers have an increased stability in comparison to the outer layer. It is also conceivable to design the outer layer in such a manner that is has a higher Shore hardness and/or a lower friction value than the inner layers. Thus, the outer layer can be provided with additives that increase the sliding ability. Such a design improves the maneuverability of the handle, which is important, particularly for professional use.

A connection piece made of plastic can be arranged on at least one end of the rod. The connection piece is used to receive a cleaning device. For this purpose, the connection piece can be provided with a thread or with a plug connector. It is conceivable to produce a separate connection piece, and to mount it on the handle; however, it is also conceivable to mold the connection piece by injection molding directly on the handle. In such a case, the connection piece is connected by material bonding to the rod. In other designs, the material connection occurs by means of an adhesive or by a welding process.

The connection piece can be introduced at least partially into the rod, and attached there. As a result, it is possible to provide a connection piece having a lower material requirement, which can thus be produced cost effectively. Moreover, the maximum diameter of the handle does not increase in the area of the connection piece.

The rod can be profiled. In this manner, the rods can have a hexagonal or oval design, for example, to improve the bending stiffness by way of the construction.

At least one layer can be made from a foamed material. Foamed material can have a special low density. In an advantageous embodiment, a layer is made of foamed material on the inside, and on the outside, of layers made of solid material. The result is a sandwich construction which has a particularly high stability and a very low density.

At least one layer can comprise organic and/or inorganic fillers. The fillers confer special properties to the layer in question. Thus, fillers by means of which the layer is dyed or fillers that increase the stability of the layer can be used. The fillers can also be designed as fibers. Said organic or inorganic fibers increase the strength of the material.

At least one layer may contain natural fibers. Natural fibers include, for example, wood fibers. The latter confer an increased stability while having a low weight. Moreover, layers made of plastic with fillers made of wood fibers have a pleasant wood-like grip.

At least one layer can comprise fiber-reinforced, reprocessed plastic. Such layers are particularly environmentally friendly due to the use of recycled plastics. Due to the fiber reinforcement, for example with glass fibers, the resulting layers have a high stability.

The inner layer of the rod can be designed to be water impermeable. In this manner, the cavity formed in the interior of the rod can be designed s liquid reservoir for a cleaning device having a spray device. In this design, the liquid reservoir is filled with a cleaning liquid.

The inner diameter of the handle can be calibrated in at least a portion of its length. In such a case, the handle is fed, after the extrusion, into a device whose inner diameter has been brought to a predetermined dimension with small allowances. The result is an improved fitting shape, particularly for connection pieces that are attached in the interior of the rod.

The handle can be segmented. In such a case, the handle consists of several rod sections. Said rod sections can be attachable by screw connection or by a plug connection. As a result, the handle length can be varied, which is particularly advantageous with regard to the packaging and the shipping of a cleaning device. The connection of the rod sections can again occur by means of connection pieces. In an additional design, the handle can be telescopic. In such a case, an additional rod with smaller diameter is inserted into the rod and it can be stopped in various positions. Thus, the length of the handle can be adapted to the user and varied continuously. In the segmented or telescopic handle, it is possible that only individual sections of the handle consist of an extruded multilayered rod. Since the remainder of the rod is subjected to increased loads due to the smaller diameter, the remaining rod should be made from a material with higher mechanical stiffness. Thus, the remaining rod can be made of metal, while the rod is made of multilayered plastic. In other designs, the remaining rod is also made of multilayered extruded plastic, but it has a fiber reinforcement.

### BRIEF DESCRIPTION OF THE SEVERAL VIEWS OF THE DRAWINGS

Several embodiment examples of the handle according to the invention are described in further detail below in reference to the figures.

FIG. 1 is a schematic, perspective view of an exemplary cleaning device with a handle according to the invention.

FIG. 2 is a schematic, cross-sectional view of the handle of FIG. 1.

FIG. 3 is a schematic, cross-sectional view of a cleaning device with an alternative embodiment of a telescoping handle according to the invention.

### DETAILED DESCRIPTION OF THE INVENTION

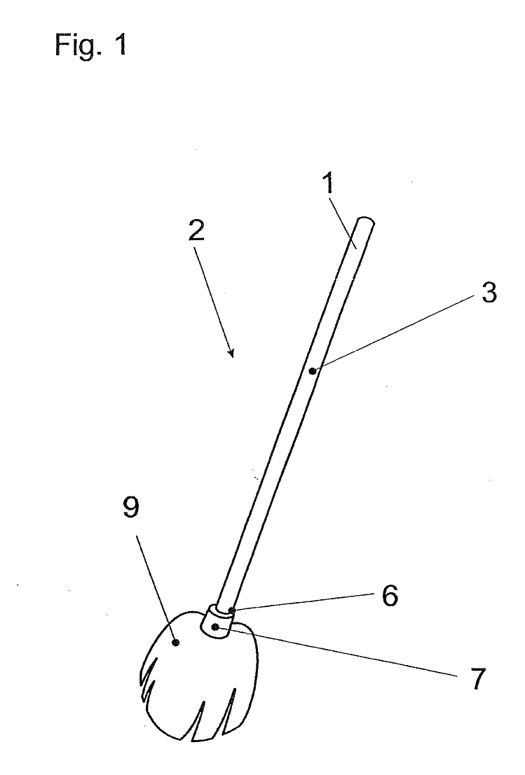

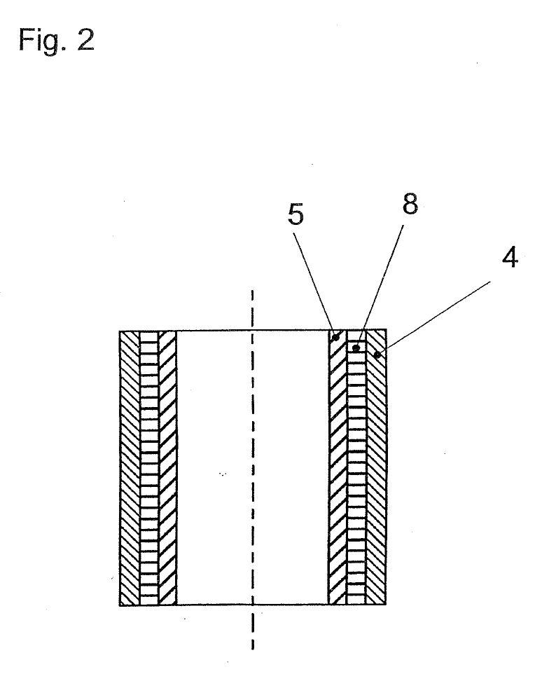

FIG. 1 shows a cleaning device 2, in this embodiment a mop brush. The cleaning device 2 consists of a handle 1 having a connection piece 7 made of plastic attached to one end 6 thereof. The mop head 9 is secured by means of a plug connection to the connection piece 7. For other cleaning devices 2, such as flat mops, brooms or dust mopping devices, a screw connection with a thread can be provided instead of the plug connection. The rod is formed from a multilayered extruded plastic rod. In this embodiment, the rod 3 has three layers. This is shown in FIG. 2 which represents the rod 3 in cross section. The materials are chosen in such a manner here that the outer layer 4 has a different Shore hardness and a different friction value than the inner layers 5. More specifically, the outer layer 4 has a lower Shore hardness and a higher friction value than the inner layers 5. The middle layer 8 consists of a foamed material, and it is integrated in a sandwich pattern between the outer layer 4 and the inner layer 5. The rod 3, in the area of the connection piece is calibrated in a process step after the extrusion, so that the inner diameter varies only within predetermined tolerances. The resulting calibrated rod 3 thus forms in its interior a recess for the connection piece 7 that is made of plastic. The connection piece 7 is partially introduced into the rod 3, attached there and connected with material connection to the rod 3. The outer layer 4 and the inner layer 5 comprise organic and inorganic fillers to improve the stability and the feel of the surface. A portion thereof is in the form of natural fibers, here wood fibers. An additional portion of the fillers is made of fiber reinforced and reprocessed plastic. The inner layer 5 of the rod 3 is designed to be water impermeable and can thus form a liquid reservoir.

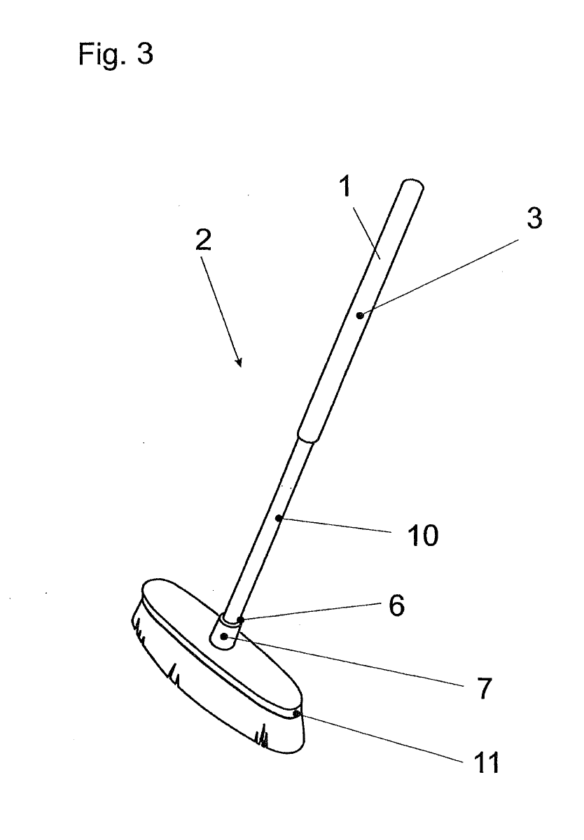

FIG. 3 shows a handle according to FIG. 1, wherein the handle 1 is segmented. The cleaning device 2, which includes the handle 1, is a broom with a broom body 11 in this case. The handle consists of a rod 3 and an additional rod 10. The rod 3 is designed as described in FIG. 1, wherein the rod 3 according to FIG. 3 is substantially the same over its entire length in terms of inner circumference. An additional rod 10 is inserted into the rod 3, wherein the additional rod 10 is continuously movable into the rod 3 and stoppable. As a result, the handle 1 is telescopic. The connection piece 7 is inserted at one end 6 into the additional rod 10. The additional rod 10 is made of a metal material.

1-15. (canceled)

16. A handle for a cleaning device comprising a rod, wherein the rod is made from a multilayered extruded plastic rod.

17. The handle according to claim 16, wherein an outer layer has a different Shore hardness and/or a different friction value than an inner layer.

18. The handle according to claim 16, wherein a connection piece made of plastic is arranged on at least one end of the rod.

19. The handle according to claim 18, wherein the connection piece is connected by material bonding to the rod.

20. The handle according to claim 18, wherein the connection piece is introduced at least partially into an interior of the rod and attached in the interior of the rod.

21. The handle according to claim 16, wherein the rod is profiled.

22. The handle according to claim 16, wherein at least one layer is made of a foamed material.

23. The handle according to claim 16, wherein at least one layer includes organic or inorganic fillers.

24. The handle according to claim 16, wherein at least one layer contains natural fibers.

25. The handle according to claim 16, wherein at least one layer comprises fiber-reinforced reprocessed plastic.

26. The handle according to claim 16, wherein an inner layer of the rod is water impermeable.

27. The handle according to claim 26, wherein the rod comprises a liquid reservoir.

28. The handle according to claim 16, wherein an inner diameter (D) of the handle is calibrated in at least a portion of its length.

29. The handle according to claim 16, wherein the handle is segmented.

30. The handle according to claim 16, wherein the handle is telescopic.
